(19) United States
(12) Patent Application Publication
(10) Pub. No.: US 2008/0101270 A1
(43) Pub. Date: May 1, 2008

(54) Enhanced multicast broadcast multimedia service

(75) Inventors: Sami J. Kekki, Helsinki (FI); Johanna Pekonen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/974,075

(22) Filed: Oct. 10, 2007

Related U.S. Application Data
(60) Provisional application No. 60/850,728, filed on Oct. 10, 2006.

(51) Int. Cl. H04H 20/71

(52) U.S. Cl. 370/312

(57) ABSTRACT

In one aspect thereof the exemplary embodiments of this invention provide a method that includes receiving and storing a set of rules; receiving an initial data unit having an indication of a time to start a downlink multicast broadcast multimedia service transmission; forming transport blocks corresponding to the data unit in accordance with the stored set of rules; and transmitting at the indicated time the transport blocks formed in accordance with the rules. In a further aspect thereof the exemplary embodiments of this invention provide a method that includes creating a table of data unit processing rules in a wireless network node and distributing the table of data unit processing rules to individual ones of a plurality of base stations that form a part of a single frequency network established to transmit multicast broadcast multimedia service transmissions to at least one user equipment.

### CLAIM OF PRIORITY FROM COPENDING PROVISIONAL PATENT APPLICATION

This patent application claims priority under 35 U.S.C. §119(e) from Provisional Patent Application No. 60/850,728, filed Oct. 10, 2006, the disclosure of which is incorporated by reference herein in its entirety.

### TECHNICAL FIELD

The exemplary and non-limiting embodiments of this invention relate generally to wireless communication systems, methods, devices and computer program products, and relate as well to techniques to provide multimedia services in a wireless communication system.

### BACKGROUND

The following abbreviations are herewith defined:

| | |
|---|---|
| 3GPP | third generation partnership project |
| UTRAN | universal terrestrial radio access network |
| E-UTRAN | evolved UTRAN |
| OFDM | orthogonal frequency division multiplex |
| Node-B | base station |
| eNB | evolved Node-B |
| UE | user equipment |
| SC-FDMA | single carrier, frequency division multiple access |
| LTE | long term evolution |
| UL | uplink (UE to Node-B) |
| DL | downlink (Node-B to UE) |
| eMBMS | evolved multicast broadcast multimedia service |
| SFN | single frequency network |
| TB | transport block |
| RNC | radio network controller |
| RLC | radio link control |
| MAC | medium access control |
| PHY | physical layer |
| PDU | packet data unit |
| GW | gateway |
| AS | access stratum |
| QoS | quality of service |
| O&M | operations and maintenance |
| MCH | multicast channel |
| MTCH | MBMS traffic channel |
| MCCH | multicast control channel |
| MCE | MBMS coordination entity |
| TNL | transport network layer |

A proposed communication system known as evolved UTRAN (E-UTRAN, also referred to as UTRAN-LTE or as E-UTRA) is currently under discussion within the 3GPP. The current working assumption is that the DL access technique will be OFDM, and the UL access technique will be SC-FDMA using cyclic prefix to achieve UL inter-user orthogonality.

One specification of interest is 3GPP TS 36.300, V8.2.0 (2007-09), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein.

Reference can be made to 3GPP TS 36.300, V8.2.0 (2007-09), generally in Section 15.1.2, “E-MBMS User Plane Protocol Architecture”, where the SYNC protocol is defined as a protocol to carry additional information that enable eNBs to identify the timing for radio frame transmission and detect packet loss. FIG. 6 herein reproduces FIG. 15.1.2-1 of 3GPP TS 36.300, V8.2.0 (2007-09), and shows the overall user plane architecture of MBMS content synchronization.

Reference can also be made to 3GPP TS 36.300, V8.2.0 (2007-09), generally in Section 15.3, “MBMS Transmission”, and more specifically in Section 15.3.3, “Multi-cell transmission”, where the following features are described.

Multi-cell transmission of MBMS is characterized by:

Synchronous transmission of MBMS within its MBSFN Area;

Combining of MBMS transmission from multiple cells is supported;

MTCH and MCCH are mapped on MCH for p-t-m transmission;

The MBSFN Transmitting, Advertising, and Reserved cells are either semi-statically configured e.g. by O&M (MBMS-dedicated cell or MBMS/Unicast-mixed cell), or are dynamically adjusted (MBMS/unicast-mixed cell) e.g. based on counting mechanisms (for future study).

The MBSFN Synchronization Area is semi-statically configured e.g. by O&M. The MBSFN Area can be semi-statically configured by O&M or (for future study) dynamically configured by MCE.

Scheduling is done by the MBMS Coordination Entity (MCE).

AMC based on non-AS level feedback is also for future study.

A carrier frequency may support more than one MCH, where the physical resource allocation to a specific MCH is made by specifying a pattern of subframes, not necessarily adjacent in time, to that MCH. This pattern is called a MCH Subframe Allocation Pattern (MSAP). Multiple MBMS services can be mapped to the same MCH and one MCH contains data belonging to only one SFA. Whether there is a 1-to-1 mapping between MCH and SFA is also for future study.

The content synchronization for multi-cell transmission is provided by the following principles:

All eNBs in a given MBSFN Synchronization Area have a synchronized radio frame timing such that the radio frames are transmitted at the same time.

All eNBs have the same configuration of RLC/MAC/PHY for each MBMS service. These may be indicated in advance by the MCE (possibly, or perhaps by the O&M).

An E-MBMS GW sends/broadcasts MBMS packet with the SYNC protocol to each eNB transmitting the service.

The SYNC protocol provides additional information so that the eNBs identify the transmission radio frame(s). The E-MBMS GW does not need accurate knowledge of radio resource allocation in terms of exact time division (e.g. exact start time of the radio frame transmission).

The eNB buffers MBMS packet and waits for the transmission timing indicated in the SYNC protocol.

The segmentation/concatenation is needed for MBMS packets and should be totally up to the RLC/MAC layer in eNB.

The SYNC protocol provides means to detect packet loss(es) and supports a recovery mechanism robust against loss of consecutive PDU packets (MBMS Packets with SYNC Header).

For the packet loss case the transmission of radio blocks potentially impacted by the lost packet should be muted.

The mechanism supports indication or detection of MBMS data burst termination (e.g., to identify and alternately use available spare resources related to pauses in the MBMS PDU data flow).

Having thus provided an overview of features of the multi-cell transmission of MBMS, as presently envisioned, it can be noted that in general MBMS has been defined as a unidirectional point-to-multipoint IP datacast service that may be used to transfer, for example, video and audio clips, and that can provide real time and high rate streaming to an audience.

As was noted above, MBMS operation in E-UTRAN (eMBMS) is currently being specified in 3GPP. One of the topics addressed thus far is a SFN operational mode of eMBMS. In the SFN mode, and for a case of multi-cell operation, all cells are to transmit exactly the same content over the air interface, with exactly the same format regarding the Layer 1 (physical layer) resources (TBs, their content and coding).

However, the problems that would arise in the MBMS SFN mode of operation are at least two-fold. First, the problem arises as to how to ensure that the TBs, their length, coding and content, is the same in each radio cell when transmitted to the UEs. If the TBs or their content were to be different, then the reception at the UE side would suffer at least due to the increased interference in such a case. That is, if the neighbor eNBs/cells are transmitting a different “bit stream” with the same radio resource at the same time, this condition will be perceived as an interfering signal in the UE receiver that will increase the interference level. The particular challenge here is that the data units received from the network that are processed into Transport Blocks can be of variable length.

A second problem that arises is how to ensure the SFN mode of operation without any significant impact on the E-UTRAN architecture, that thus far has been designed for unicast (i.e., not MBMS) operation.

It has been suggested that eMBMS may require a centralized logical element in the E-UTRAN architecture, where the radio interface functions related to TB formation would occur. The use of this approach would presumably ensure that all radio cells in the SFN mode of operation would receive similar TBs for any given eMBMS data stream, and the TBs would not be formed autonomously as is the case for, by example, unicast traffic.

However, the introduction of such a centralized element in the E-UTRAN architecture would be a major departure from the “flat”, RNC-less architecture for unicast traffic. In the flat architecture of the E-UTRAN system there would ideally not be any centralized radio network element, and instead all radio network processing, especially in the user plane, would reside in the LTE base station, i.e., in the eNodeBs (eNBs).

Further reference with regard to certain MBMS features can be made to, for example,

3GPP TSG-RAN WG 3 Meeting #53bis, R3-061534, Seoul, Korea, 10 Oct.-13 Oct., 2006, “Architecture for Content Synchronisation”, Alcatel;

3GPP TSG-RAN3#54, R3-061661, Riga, Latvia, 6-10 Nov. 2006, “Content synchronization scheme with segmentation and concatenation in eNB”, NTT DoCoMo; and

3GPP TSG RAN WG3 #54 R3-061681, Riga, Latvia, 6-10 Nov. 2006, “LTE MBMS SFN: Super-frame Based Content Synchronisation”, IPWireless.

### SUMMARY OF THE EXEMPLARY EMBODIMENTS OF THIS INVENTION

The foregoing and other problems are overcome by the use of the exemplary embodiments of this invention.

In one aspect thereof the exemplary embodiments of this invention provide a method that includes receiving and storing a set of rules; receiving an initial data unit that comprises an indication of a time to start a downlink multicast broadcast multimedia service transmission; forming transport blocks corresponding to the data unit in accordance with the stored set of rules; and transmitting at the indicated time the transport blocks formed in accordance with the rules.

In another aspect thereof the exemplary embodiments of this invention provide an apparatus that comprises a memory configurable to and store a set of rules; a unit configurable to receive an initial data unit that comprises an indication of a time to begin a downlink multicast broadcast multimedia service transmission and a processor configurable to form transport blocks corresponding to the data unit in accordance with the stored set of rules; and a wireless transmitter to transmit the transport blocks at the indicated time in cooperation with transport blocks transmitted by other apparatus using a same transmission frequency.

In another aspect thereof the exemplary embodiments of this invention provide an apparatus that comprises means for storing a set of rules; means for receiving an initial data unit that comprises an indication of a time to begin a downlink multicast broadcast multimedia service transmission and for forming transport blocks corresponding to the data unit in accordance with the stored set of rules; and means for transmitting the transport blocks at the indicated time in cooperation with transport blocks transmitted by other apparatus using a same transmission frequency.

In a further aspect thereof the exemplary embodiments of this invention provide a method that includes creating a table of data unit processing rules in a wireless network node and distributing the table of data unit processing rules to individual ones of a plurality of base stations that form a part of a single frequency network established to transmit multicast broadcast multimedia service transmissions to at least one user equipment.

In yet another aspect thereof the exemplary embodiments of this invention provide an apparatus that comprises means for creating a table of data unit processing rules at a wireless network node and means for distributing the table of data unit processing rules to individual ones of a plurality of base stations that form a part of a single frequency network established to transmit multicast broadcast multimedia service transmissions to at least one user equipment.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIGS. 2A and 2B illustrate SFN operation of the UE of FIG. 1 for a case of cells with strictly synchronized TB content and coding, and for a case where one of the cells is out of synchronization, respectively.

FIG. 3 illustrates an exemplary set of transport block composition rules for use by the eNBs of FIG. 1 during SFN eMBMS operation.

FIGS. 4 and 5 are logic flow diagrams that are illustrative of the execution of methods and computer programs in accordance with the exemplary embodiments of this invention.

FIG. 6 reproduces FIG. 15.1.2-1 of 3GPP TS 36.300, V8.2.0 (2007-09), and shows the overall user plane architecture of MBMS content synchronization.

### DETAILED DESCRIPTION

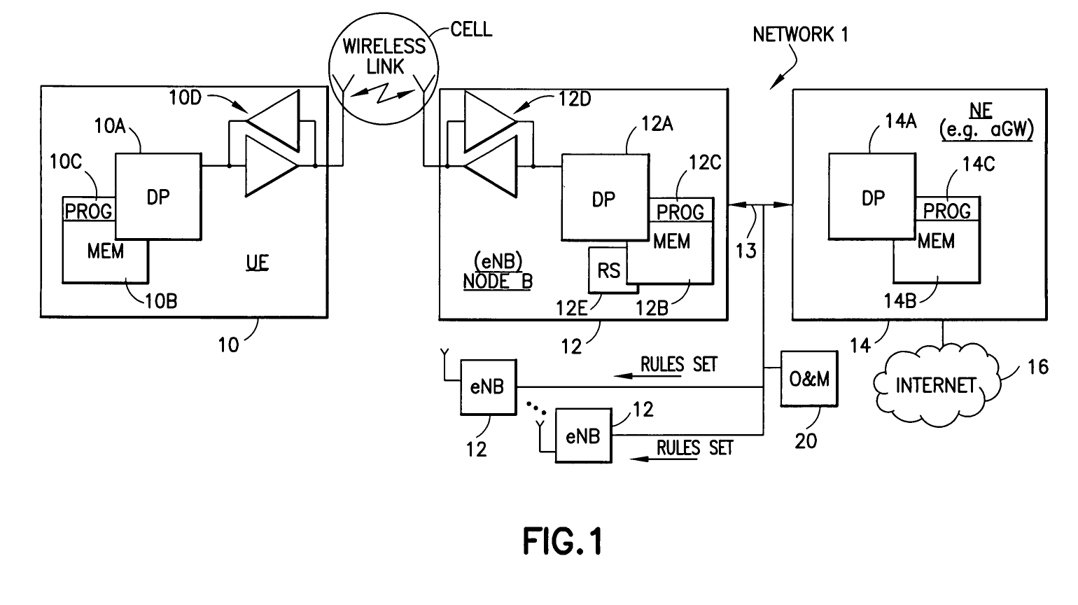

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via an eNB (base station) 12. The network 1 may include a network element (NE) 14 such as an access gateway (aGW) or an e-MBMS gateway that provides a connection to the internet 16. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The eNB 12 is coupled via a data path 13 to the NE 14 that also includes a DP 14A and a MEM 14B storing an associated PROG 14C. At least the PROG 12C is assumed to include program instructions that, when executed by the associated DP, enable the electronic device to operate in accordance with the exemplary embodiments of this invention, as will be discussed below in greater detail. That is, the exemplary embodiments of this invention may be implemented at least in part by computer software executable by at least the DP 12A of the eNB 12, or by hardware, or by a combination of software and hardware.

In practice there will be a plurality of eNBs 12, as shown in FIG. 1, that in the SFN eMBMS operational case transmit the same content using the same radio frequency.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

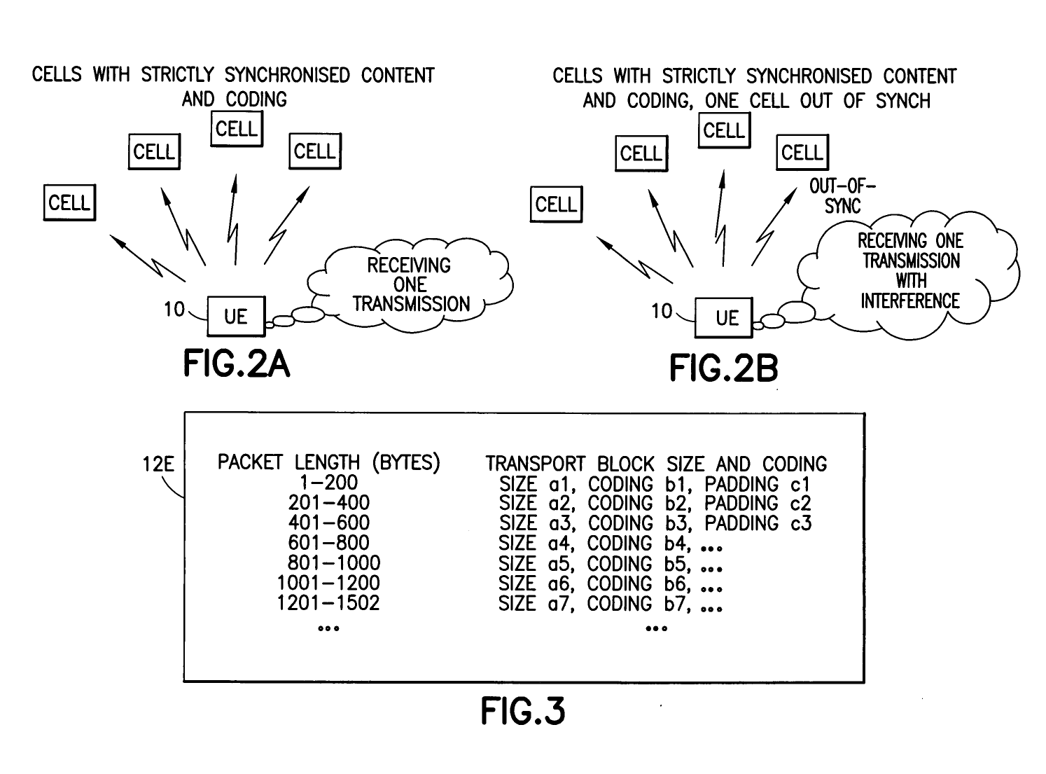

FIGS. 2A and 2B illustrate SFN operation of the UE 10 for a case of cells with strictly synchronized TB content and coding, and for a case where one of the cells is out of synchronization, respectively. Note that in FIG. 2B the UE 10, instead of receiving one transmission, receives the one transmission with interference due to the out-of-synch eNB 12 in the affected cell.

The use of the exemplary embodiments of this invention in the system 1 of FIG. 1 removes any need for centralized TB processing, and enables all TBs to be formed locally in each radio cell (i.e., by each eNB 12). This is accomplished by distributing a rules table or rules set (RS) 12E in advance to each eNB 12 that is, or that may become involved in the SFN operation of eMBMS. The rules set 12E in one non-limiting embodiment may specify a mapping between a received data unit size (e.g., the size of a received IP packet) and the manner in which the data unit is processed into one or more TBs. After the rules set 12E is received from a wireless network element or node, such as from an O&M network element 20, it is preferably stored in the memory 12B for subsequent use, as described below.

FIG. 3 illustrates an exemplary set of eMBMS rules 12E for use by the eNB 12 for SFN operation. In this non-limiting example there is specified for various ranges of packet length (in bytes) the corresponding TB size and coding (including padding). Each of the eNBs 12 in FIG. 1 may be provisioned with the same rules set 12E and, as a result, the TB generation is unified amongst the plurality of eNBs 12 when operating in the eMBMS SFN mode. The result is operation from the UE 10 standpoint as in FIG. 2A, as opposed to operation as in FIG. 2B.

It is noted that the number of rules in the rule set 12E can vary based on the level of optimization desired, as well as based on other criteria.

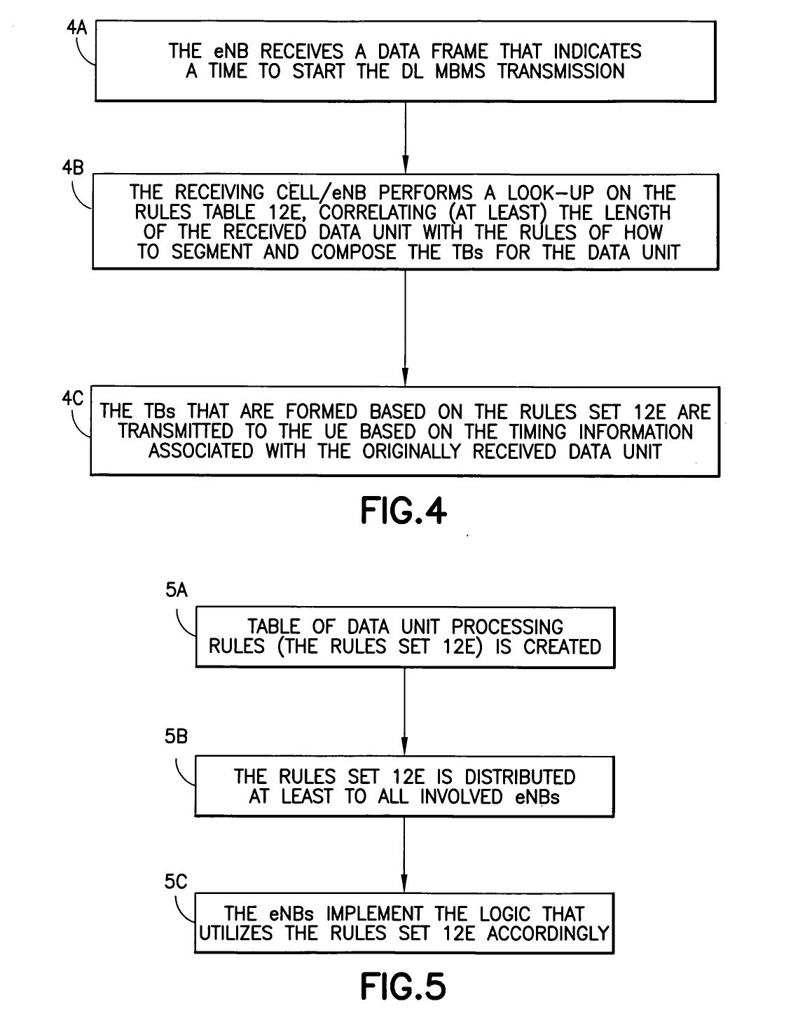

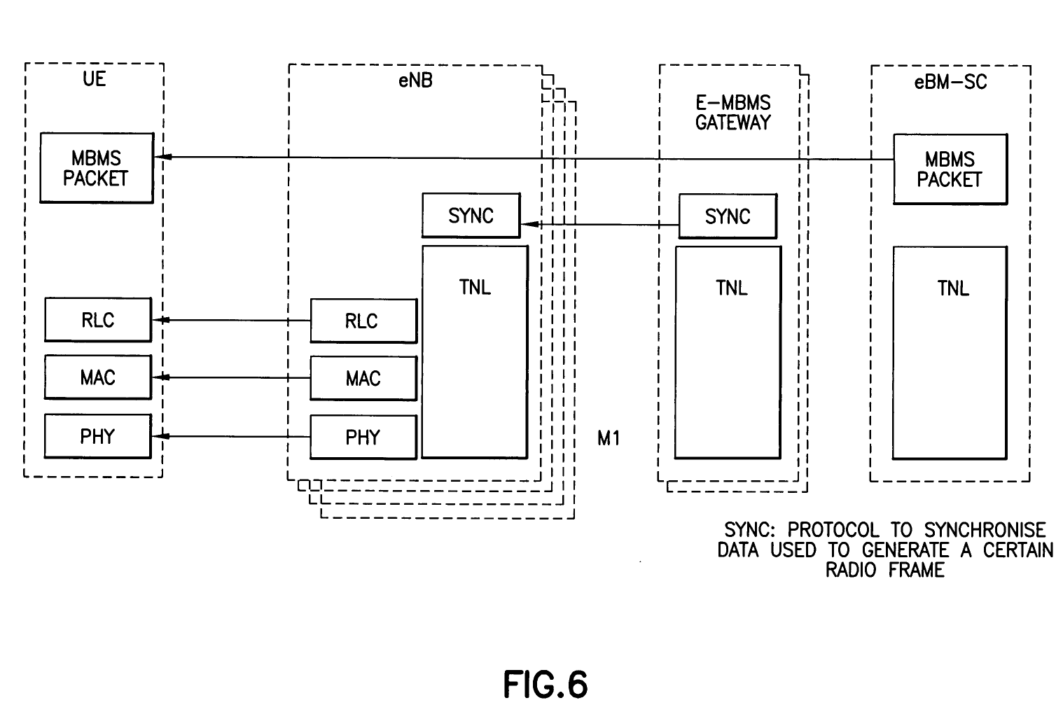

In the use of the exemplary embodiments of this invention, and referring to FIG. 4, it may be assumed that there is a sequence number in a header of a received data frame for indicating the radio interface timing of the data unit, such as when the data unit or first segment of the data unit is be sent over the wireless link to the UE 10. Thus, at Block 4A the eNB 12 receives a data frame that indicates a time to start the DL MBMS transmission. At Block 4B the receiving cell/eNB 12 performs a look-up on the rules table 12E, correlating the length of the received data unit with the rules of how to segment and compose the TBs for the data unit. Note that segmenting and composing may generally indicate establishing a size of the transport blocks, the coding for the transport blocks and an amount of padding (if any) in each transport block, as non-limiting examples. The length of the received data unit may be the primary element used in the correlation. However, the QoS of the data unit may be another element used in the correlation. There may also be factors considered in making the correlation. For example, the QoS parameters may contain information concerning a requested data rate (e.g., a guaranteed bit rate a maximum bit rate). This information can be used in the rules set 12E to define how many TBs there should be, and in which subframes they should be transmitted. Other parameters of interest can include the bit error rate (BER), which may be used to adjust the coding as needed to achieve a desired BER.

At Block 4C the TBs that are formed based on the rules set 12E are then transmitted to the UE 10 based on the timing information associated with the originally received data unit.

Further in accordance with the exemplary embodiments of this invention, and referring to FIG. 5, at Block 5A the table of data unit processing rules (the rules set 12E) is created, and at Block 5B the rules set 12E is distributed at least to all involved eNBs 12. At Block 5C the eNBs 12 implement the logic that utilizes the rules set 12E accordingly. The distribution of the rules set 12E to the eNBs 12 may be performed, as one non-limiting example, via the O&M unit 20 as part of node radio configuration information, and/or through the use of application signaling in a dynamic fashion at the time when the SFN service is created. The O&M unit 20 (or whatever network unit or node may be responsible for forming/creating/managing the table of rules) is assumed to include a suitable data processor and other related circuitry and computer code functions for forming the rules set and for distributing the rules set to the various eNBs 12 for storage as the rules set 12E.

The various blocks shown in FIGS. 4 and 5 may be viewed as method steps, and/or as operations that result from operation of computer program code executed by the DPs 12A of the eNBs 12, and/or as a plurality of coupled logic circuit elements constructed to carry out the associated function(s).

One significant advantage that may be realized by the use of this invention is that it allows a flat E-UTRAN radio network architecture to be used for provisioning eMBMS, thus allowing a similar architecture for both unicast traffic (an architecture already defined in 3GPP) and MBMS traffic. The ability to perform the SFN operation without the use of the exemplary embodiments of this invention may not be feasible, as the similar treatment of data units by the eNBs 12 in all cells cannot be ensured.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while described in the context of the LTE (E-UTRAN) wireless communication system, the various exemplary aspects of this invention may be employed in other types of wireless communications systems where it is desirable to provide a downlink multicast broadcast multimedia service, or a similar type of service.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
receiving and storing a set of rules;
receiving an initial data unit that comprises an indication of a time to start a downlink multicast broadcast multimedia service transmission;
forming transport blocks corresponding to the data unit in accordance with the stored set of rules; and
transmitting at the indicated time the transport blocks formed in accordance with the rules.

2. The method of claim 1, where forming comprises:
performing a look-up on the set of rules using a size of the data unit; and
segmenting and composing the transport blocks corresponding to the data unit. in accordance with a rule identified during the look-up.

3. The method of claim 2, where segmenting and composing further comprises considering a quality of service associated with the data unit.

4. The method of claim 1, executed by a base station that forms a part of a wireless communication system, where the set of rules is received, in common with at least one other base station, from a network node of the wireless communications system.

5. The method of claim 1, where the set of rules is received as part of node radio configuration information.

6. The method of claim 1, where the set of rules is received by application signaling at a time when a single frequency network service is created.

7. The method of claim 1, where the set of rules comprises a plurality of members, each member being associated with a range of packet lengths and indicating at least, for each range of packet lengths, a transport block size and coding.

8. The method of claim 1, performed as a result of execution of computer program instructions stored in a computer readable memory medium that forms a part of a base station, such as an evolved Node-B.

9. An apparatus, comprising:
a memory configurable to and store a set of rules;
a unit configurable to receive an initial data unit that comprises an indication of a time to begin a downlink multicast broadcast multimedia service transmission;
a processor configurable to form transport blocks corresponding to the data unit in accordance with the stored set of rules; and
a wireless transmitter to transmit the transport blocks at the indicated time in cooperation with transport blocks transmitted by other apparatus using a same transmission frequency.

10. The apparatus of claim 9, where said processor is configurable to perform a look-up on the set of rules using a size of the data unit and to form the transport blocks corresponding to the data unit. in accordance with a rule identified during the look-up.

11. The apparatus of claim 10, where the processor further considers a quality of service associated with the data unit.

12. The apparatus of claim 9, embodied in a base station that forms a part of a wireless communication system, where the set of rules is received, in common with at least one other base station, from a network node of the wireless communications system.

13. The apparatus of claim 9, where the set of rules is received as part of node radio configuration information.

14. The apparatus of claim 9, where the set of rules is received by application signaling at a time when a single frequency network service is created.

15. The apparatus of claim 9, where the set of rules comprises a plurality of members, each member being associated with a range of packet lengths and indicating at least, for each range of packet lengths, a transport block size and coding.

16. The apparatus of claim 9, where said processor executes computer program instructions stored in a computer readable memory medium that forms a part of a base station, such as an evolved Node-B.

17. An apparatus, comprising:
means for storing a set of rules;
means for receiving an initial data unit that comprises an indication of a time to begin a downlink multicast broadcast multimedia service transmission and for forming transport blocks corresponding to the data unit in accordance with the stored set of rules; and
means for transmitting the transport blocks at the indicated time in cooperation with transport blocks transmitted by other apparatus using a same transmission frequency.

18. The apparatus of claim 17, where said receiving and forming means performs a look-up on the set of rules using a size of the data unit and forms the transport blocks corresponding to the data unit. in accordance with a rule identified during the look-up, where the set of rules comprises a plurality of members, each member being associated with a range of packet lengths and indicating at least, for each range of packet lengths, a transport block size and coding.

19. The apparatus of claim 18, where the processor further considers a quality of service associated with the data unit.

20. The apparatus of claim 17, embodied in a base station that forms a part of a wireless communication system, where the set of rules is received, in common with at least one other base station, from a network node of the wireless communications system as part of node radio configuration information or as by application signaling at a time when a single frequency network service is created.

21. The apparatus of claim 17, embodied in a base station, such as an evolved Node-B.

22. A method, comprising:
creating a table of data unit processing rules in a wireless network node; and
distributing the table of data unit processing rules to individual ones of a plurality of base stations that form a part of a single frequency network established to transmit multicast broadcast multimedia service transmissions to at least one user equipment.

23. The method of claim 22, where the table of data unit processing rules is configured to direct the base stations to form transport blocks corresponding to a data unit and comprises a plurality of members, each member being associated with a range of packet lengths and indicating at least, for each range of packet lengths, a transport block size and coding.

24. An apparatus, comprising:
means for creating a table of data unit processing rules at a wireless network node; and
means for distributing the table of data unit processing rules to individual ones of a plurality of base stations that form a part of a single frequency network established to transmit multicast broadcast multimedia service transmissions to at least one user equipment.

25. The apparatus of claim 24, where the table of data unit processing rules is configured to direct the base stations to form transport blocks corresponding to a multicast broadcast multimedia service data unit and comprises a plurality of members, each member being associated with a range of data packet lengths and indicating at least, for each range of data packet lengths, a transport block size and coding to be used when transmitting the data unit to the at least one user equipment.
